(19) United States
(12) Patent Application Publication
(10) Pub. No.: US 2026/0226954 A1
(43) Pub. Date: Aug. 6, 2026

(54) A DISC FOR USE IN A DISC SPRING, AND A DISC SPRING ASSEMBLY COMPRISING THE DISC

(71) Applicant: Tomax AS, STAVANGER (NO)

(72) Inventor: Nils Reimers, BJOA (NO)

(73) Assignee: Tomax AS, STAVANGER (NO)

(21) Appl. No.: 19/142,745

(22) PCT Filed: Jan. 22, 2024
(86) PCT No.: PCT/NO2024/050014

§ 371 Date: Jun. 24, 2025

(30) Foreign Application Priority Data
Feb. 2, 2023 (NO) 20230101

(51) Int. Cl. F16F 1/32; F16F 3/02

(52) U.S. Cl. CPC F16F 1/32; F16F 3/023; F16F 2226/04; F16F 2238/022

(57) ABSTRACT

A disc is for a disc spring, and an assembly having pairs of such discs. The disc has a first face; a second face opposite the first face; a central bore extending through the disc; and a perimeter face, wherein the first face has a first portion having a direction component extending radially from the perimeter face towards the central bore; and a second portion between the first portion and the central bore. The first portion is planar and arranged at a first angle with respect to a central axis of the bore, and the second portion has at least a part arranged at a second angle with respect to the central axis of the bore, and wherein the second angle is smaller than the first angle.

### CROSS-REFERENCE TO RELATED APPLICATIONS

This application is the U.S. national stage application of International Application No. PCT/NO2024/050014, filed Jan. 22, 2024, which international application was published on Aug. 8, 2024, as WO 2024/162856 in the English language. The International Application claims priority to Norwegian Patent Application No. 20230101, filed on Feb. 2, 2023. The international application and Norwegian application are both incorporated herein by reference, in their entirety.

### FIELD

The present invention is related to an improved disc or washer for use in a disc spring, and a disc spring assembly comprising the disc.

### BACKGROUND

In known art, a disc spring is also known as a Belleville spring. Belleville springs are generally flat, like that of a washer, but are classified as conical springs, since their centres are raised, which creates a cone. This cone shape is what gives a Belleville spring its heavy-duty strength. The disc springs are scalable to practically any dimension. That also means that it can be configured and adapted to very high loads, much higher than for example coil springs. It can also be made from a variety of materials. This great versatility makes the disc spring useful for a large variety of applications across many industries.

However, a known limitation to the disc spring comes when trying to meet the need for high axial force in combination with extended stroke. The need for a long stroke is met by adding up larger or longer stacks of discs. This also results in an increased number of interfaces, which increases the loss to friction in both compression and extension. The loss is caused by any misalignment between each disc in the stack of discs and, with a longer stroke, also external forces resisting the motion. These external forces are resulting from the need to guide and stabilise longer stacks of discs by means of a guiding member.

Guiding of the disc spring is complicated by the fact that the external diameter as well as the internal diameter or bore varies with compression and extension because of the cone-shape of the discs. Thus, a guiding system, such as an internal and/or external guiding member that may be needed for a disc spring, must allow a certain play. An internal guiding member may for example be a hollow or solid rod, while an external guiding member may be a sleeve or guides enclosing at least portions of a circumference of the discs in a disc spring. Such a play results in that the discs may move in several directions when deflecting or being unloaded. If not perfectly aligned, some of that movement will be up against the guiding member and, if acting from different directions through a long stack, significant restrictions to deflection can be accumulated. Such accumulated restrictions caused by misalignment represent major challenges of a long or high stack of disc springs and is therefore unsuitable for certain applications. By a long or high stack is meant a stack of discs comprising at least 10 pairs of discs.

It can be challenging to achieve a more accurate guiding so that the losses from friction between the individual discs are reduced. Due to the varying external and internal diameters during compression and extension of the cone shaped discs, sufficiently fine tolerances to mitigate the lack of accurate guiding are difficult to achieve without compromising a capacity of the disc springe. As a result, a stack of discs needs a certain play with respect to the guiding system, independently of the guiding system being an internal guiding member (through a central bore of the discs) or external guiding member (surrounding a perimeter of the discs), or a combination thereof.

Based on the unpredictable factors in terms of efficiency and friction, manufacturers and technical experts will typically set a limit at around twenty discs in one stack of disc springs, i.e. ten pairs of discs. The number considers the finest, allowable tolerances and best possible lubrication. Experience and tests show that a longer stack of discs will result in accumulations of friction that will result in a so-called moving end of the disc spring being overloaded, while other parts of the disc spring will have a compression being typically less than half the compression of the moving end. In addition to the high risk of premature fatigue of the discs at the moving end, the result of an extensive or long stack of discs is a more passive section that will absorb applied force and reduce the predicted stroke of the disc spring. This also means a returning spring force stored at any given stroke-length becomes less and creates a big difference or “gap” in mechanical energy between the compressive force and the available returning force. This effect of loss of mechanical energy from friction under cyclic loading and unloading is commonly known as the hysteresis of the spring.

Known disc springs are typically made from hardened steel adapted for optimal spring characteristics but can also be made by advanced materials, such as for example titanium and composite materials. Notwithstanding, the fundamental friction issues discussed above are independent of the material of the discs in a disc spring.

A known alternative to a disc spring for providing strong, long stroke springs may be a dampening device being based on compressed gas. However, in larger dimension, for example a diameter of the discs being larger than about 100 mm, a gas spring and external accumulator represents a serious hazard and is generally avoided in the industry. Therefore, there is still a need in the industry for an effective, stiff, mechanical spring capable of providing a long stroke.

Publication U.S. Pat. No. 4,276,947 A discloses a disc spring. The discs of the disc spring comprise curved contact interfaces for providing rolling interface between the discs in a long stack to reduce losses to friction during compression and deflection in a deep drilling oil tool.

The disc spring in U.S. Pat. No. 4,276,947 A made a long stack less sensitive to misalignment. The rolling interface between the discs results in a high-pressure tangential contact point. This high contact pressure means the springs would not easily slip internally.

The disc spring of U.S. Pat. No. 4,276,947 represents an advantage with respect to friction for abutting disc faces. However, the high contact pressure between abutting discs represents a disadvantage for any discs abutting against an internal or external spring guiding member. The external friction problem from the dimensional change during compression and extension would at best be unaffected by the disc spring disclosed in U.S. Pat. No. 4,276,947 A.

Publication JPS5534567U discloses a disc for a disc spring wherein an inner diameter end edge comprises a flat surface.

Publication US2014138205A1 discloses a disc spring for use in a clutch apparatus. In one embodiment, a primary coned disc is provided with a flat portion wherein the entire surface of the flat portion can come into contact with a counter member first when a load is applied.

Publication DE102006052309A1 discloses a disc for a disc spring assembly wherein an inner edge of the disc is bevelled.

### SUMMARY

The invention will now be disclosed and has for its object to remedy or to reduce at least one of the drawbacks of the prior art, or at least provide a useful alternative to prior art. The object is achieved through features, which are specified in the description below and in the claims that follow. The invention is defined by the independent patent claims. The dependent claims define advantageous embodiments of the invention.

In a first aspect the invention relates to a disc for a disc spring, the disc comprising: a first face forming a surface of a concave face of the disc; a second face opposite the first face; a central bore extending through the disc; and a perimeter face. The first face comprises a first portion having a direction component extending radially from the perimeter face towards a central axis of the bore; and a second portion between the first portion and the central bore, wherein the first portion is planar and arranged at a first angle with respect to the central axis of the bore, and the second portion comprises at least a part arranged at a second angle with respect to the central axis of the bore, wherein the second angle is smaller than the first angle. The disc is configured so that the first angle is smaller than 90° with respect to a central axis of the bore when the disc is unloaded, and the first angle is larger than 90° with respect to the central axis of the bore when the disc is subject to a load being at least 30% of a design load of the disc.

A characteristic of a disc spring depends on i.a. the characteristics of the individual discs forming the spring. The characteristic of each disc depends on the shape (degree of con-cavity/convexity), thickness between the first face and second face, the properties of materials from which the disc is formed, and any heat treatment of the material. Thus, the first angle is determined based on the desired characteristic of the disc, and the desired characteristic of the disc spring comprising a plurality of discs.

Preferably, the disc is configured so that first angle changes from an acute angle to an obtuse angle when the disc is subject to a load being in the range of 30-50% of the design load of the disc. The first face is a face or surface of the concave portion of a cone shaped disc, and the second face is a face or surface of a convex portion of the disc.

The first portion of the first face is slanting from an edge bordering the perimeter face of the disc. This means that the first portion has a direction component extending radially from the perimeter face towards the central axis of the bore, and a direction component extending in parallel with the central axis of the bore. The first face may, for example, be annular so that the first portion defines an annular plane extending from the perimeter face of the disc towards the central bore of the disc. A transition between the surface of first portion and the surface of the second portion may have a break.

The effect of the first portion of the first face is to provide an abrupt shift of contact area within a pair of discs when being compressed past a predetermined level. An abrupt shift of contact area within a pair of discs takes place also when a compression force is relieved. An abrupt shift in contact area within a pair of discs provides a “rocking effect” or abrupt transition of loading area that facilitates alignment of a stack of discs as will be discussed in detail below.

In one embodiment of the invention there is provided a disc for a disc spring, the disc comprising: a first face forming a surface of a concave face of the disc; a second face opposite the first face; a central bore extending through the disc; and a perimeter face. The first face comprises a first portion having a direction component extending radially from the perimeter face towards a central axis of the bore; and a second portion between the first portion and the central bore, wherein the first portion is planar and arranged at a first angle with respect to the central axis of the bore, and the second portion comprises at least a part arranged at a second angle with respect to the central axis of the bore, wherein the second angle is smaller than the first angle; and wherein the disc in a position of use is configured to abut against an identical inverted disc so that the discs form a pair of discs wherein a portion of the first faces abut against each other. In a position of use, the first angle is configured to form a gap between the first portions facing the central axis of the bore when the discs are uncompressed, and a gap facing the perimeter face when the discs are fully compressed.

In one embodiment, the second face of the disc extends rectilinearly from the central axis of the bore to the perimeter face. Thus, the second face of the disc may be similar to a second face of a disc according to prior art commonly available in the marked. Providing a disc having a second face being similar to discs available in the marked has the effect that a disc according to the invention may be provided by means of a “standard disc” being machined on a portion of the first face only.

In an alternative embodiment, the second face of the disc may comprise a third portion extending from the bore and towards the perimeter face and having a direction component extending radially from the central axis of the bore; and a fourth portion between the third portion and the perimeter face of the disc, wherein the third portion is planar and arranged at a third angle with respect to the central axis of the bore, and the fourth portion comprises at least a part arranged at a fourth angle with respect to the central axis of the bore, and wherein the fourth angle is smaller than the third angle.

The disc may be configured so that the third angle is smaller than 90° with respect to a central axis of the bore when the disc is unloaded, and the third angle is larger than 90° with respect to the central axis of the bore when the disc is subject to a load being at least 30% of a design load of the disc.

Preferably, the disc is configured so that third angle changes from an acute angle to an obtuse angle when the disc is subject to a load being in the range of 30-50% of the design load of the disc.

The third portion having a direction component extending radially from the central axis of the bore towards the perimeter face may be annular, so that the third portion defines an annular plane extending from the central bore of the disc and a certain distance towards the perimeter face of disc.

When in a position of use in a pair of discs, the effect of the third portion is similar to the first portion of the first face. An abrupt shift in contact area between two pairs of discs is achieved.

In one embodiment, the angle of the third portion is similar to the angle of the first portion, i.e. the third portion and the first portion of the second and first face, respectively, may be parallel within machining tolerances. The effect of such parallel portions will be explained below. The angle of the fourth portion and the angle of the second portion may in one embodiment be parallel within machining tolerances.

In a second aspect of the invention being an alternative to the first aspect of the invention, there is provided a disc for a disc spring wherein the disc comprises a first face and a second face opposite the first face, a central bore extending through the disc, and a perimeter face. The second face has a third portion having a direction component extending radially from the central axis of the bore towards the perimeter face; and a fourth portion between the third portion and the perimeter face; the third portion being planar and arranged at a first angle with respect to a central axis of the bore, and the fourth portion having at least a part arranged at a second angle with respect to the central axis of the bore, the second angle being smaller than the first angle, wherein the second face is a convex face of the disc. In this alternative embodiment, the disc may be configured so that the first angle of the second face is smaller than 90° with respect to a central axis of the bore when the disc is unloaded, and the first angle of the second face is larger than 90° with respect to the central axis of the bore when the disc is subject to a load being at least 30% of a design load of the disc.

In the second aspect of the invention, the first face extends rectilinearly between the bore and the perimeter face of the disc.

In a third aspect of the invention, a spring assembly is provided, the assembly comprising:
pairs of discs, wherein each disc in the pairs of discs includes a disc according to the first or second aspect of the invention; and
   an aligning member for radially aligning the pairs of discs, wherein, in each pair of discs, a portion of the first face of one disc abuts against a portion of the first face of other disc. The first portions in a pair of discs form a gap facing a central axis of the bores of the discs when the assembly is uncompressed, and a gap facing the perimeter face when the disc spring assembly is subject to a compressive force being at least 30% of the design load of the disc spring assembly.

The aligning member may be a mandrel arranged through the central bore of each disc, or a guide encompassing at least portions of the perimeter faces of the discs.

By arranging each pair of discs so that a portion of the first faces abut against each other, wherein each disc has a first planar portion arranged at a first angle with respect to a central axis of the bore, and the second portion having at least a part arranged at a second angle being smaller than the first angle as recited in the first aspect of the invention, a contact between the pair of discs will depend from the degree of compression of the spring, both with respect to position and, importantly, with respect to an area of contact between the first planar portions.

In such an embodiment, at least in an unloaded condition, the discs in each pair of discs in a fully aligned assembly are configured for being on contact with each other at the outer perimeter or edge of the first planar portions only. If the discs in a pair of discs are mutually radially displaced or offset, one of the edges in the pair of discs abuts against the first portion of the other disc in the pair of discs. Thus, independently of the pair of discs being fully aligned or mutually offset, in an unloaded or uncompressed condition the abutting first planar portions provides a gap facing a central axis of the bores of the discs. At least in the fully loaded condition, i.e. fully compressed condition, the discs in the disc spring assembly are configured for being in contact with each other at the first planar portion bordering the second portion between the first portion and the central bore only, i.e., the discs are in contact at inner transition boundaries between the first portion and the second portion of the first face. Thus, as discussed above, the abutting first planar portions provides a gap facing the outer perimeter of the discs. Therefore, during loading and unloading of the stacked spring assembly, the contact between the discs in a pair of discs, will reciprocate between the contact positions as described above. During such a reciprocating movement, the planar first portions of pairs of discs will at a certain compression be in parallel with each other. Depending on a load rate, the planar first portions may be in parallel for a very short period of time, in some cases for less than a second, or for a longer time, or even continuously if the load applied to the stacked spring assembly is constant and compresses the discs so that the planar first portions of pair of discs are in parallel.

By providing a spring disc assembly comprising discs according to the second aspect of the invention, the effect will be similar, but wherein a gap between the third planar portion of the second face of abutting pairs of discs, will be opposite to the gaps as discussed above wherein the discs are according to the first aspect of the invention, i.e. the gap will face away from the central bore of the disc assembly when the disc assembly is in an extended, unloaded state, and the gap will face the central bore when the disc assembly is fully loaded.

The inventor has during comprehensive testing surprisingly found that the above configuration of a stacked spring assembly, provides a “self-aligning” spring, that at least reduces prior art friction challenges both with regards to internal friction between the discs, and with regards to friction towards any guiding member being necessary for extended stacks of disc springs. The guiding member may be at least one of a mandrel arranged through the central bore of each disc as mentioned above, and an external aligning member configured to enclose the perimeter face of the discs. An external aligning may be a sleeve or guide configured for encompassing all or portions of the perimeter faces of the discs.

Tests have indicated that the configuration of a disc spring assembly comprising discs according to the first aspect of the invention is preferred over a disc spring assembly comprising discs according to the second aspect of the invention, because the first mentioned disc configuration is more effective with respect to self-alignment. A plausible reason for this may be that the first portion of the first face has a greater area than a corresponding portion third portion on the second face bordering the central bore. By corresponding is meant having a same width or extension in a radial direction. Thus, when subject to the same compressive force, a friction between abutting first portions of the first face will be less than a friction between abutting third portions of the second face. The lower friction, the better self-alignment of the disc spring assembly during compression or unloading of the assembly.

A disc spring assembly according to the invention is in one embodiment configured with the discs arranged in series. However, a self-aligning effect is also achieved for a so-called series-parallel configuration of the disc spring assembly. A series-parallel configuration may be preferred in embodiments wherein an internal dampening effect of the disc spring is desired.

In a fourth aspect of the invention there is provided a method for aligning a disc spring assembly according to the third aspect of the invention, wherein the method comprises the step of: providing an axial load on a moving end of the disc spring assembly so that the disc spring is compressed to at least allow the first portions of the first faces in a pair of discs to be parallel. Preferably, the method comprises applying compressive force sufficient to provide an abrupt shift so that a contact area between the discs is shifted from the edges at the perimeter of the discs to the transition boundaries. In a preferred embodiment, the abrupt shift is caused by applying a compressive force being at least 30% of the design load of the disc.

### BRIEF DESCRIPTION OF THE DRAWINGS

In the following, examples of preferred embodiments illustrated in the accompanying drawings are described, wherein:

FIG. 1a shows a prior art disc or washer for use in a disc or Belleville spring, seen towards a convex portion of the disc;

FIG. 1b shows a cross-section through P-P of the prior art disc shown in FIG. 1a;

FIG. 2a shows an embodiment of disc or washer according to the invention, the disc is for use in a disc or Belleville spring, wherein the disc is seen towards a convex portion of the disc;

FIG. 2b shows a cross-section through A-A of the disc shown in FIG. 2a;

FIG. 3a shows in a smaller scale a pair of stacked discs shown in FIG. 2b, wherein the discs are in a non-compressed state;

FIG. 3 b shows in larger scale detail B of FIG. 3a;

FIG. 4a shows the stacked discs shown in FIG. 3a after being partly compressed;

FIG. 4b shows in larger scale detail C of FIG. 4 a;

FIG. 5a shows the stacked discs shown in FIG. 3a, wherein the discs are in a non-compressed state;

FIG. 5 b shows in larger scale detail D of FIG. 5a;

FIG. 6a shows an alternative embodiment of the disc shown in FIG. 2b;

FIG. 6b shows a stack of discs shown in FIG. 6A;

FIGS. 7a and 7b illustrate an operating principle of aligning a stack of springs comprising discs as shown in FIG. 2b; and

FIG. 8 is a graph illustrating a comparison of deflection of a Belleville spring comprising prior art discs and discs according to the invention.

### DETAILED DESCRIPTION OF THE DRAWINGS

The drawings are shown in a schematic and simplified manner, and features that are not necessary for explaining the invention may be left out. Identical reference numerals refer to identical or similar features in the drawings. For clarity reasons, some elements may in some of the figures be without reference numerals. The various features shown in the drawings may not necessarily be drawn to scale. A person skilled in the art will under-stand that the figures are just principal drawings. The relative proportions of individual elements may also be distorted. Any positional indications refer to the position shown in the figures.

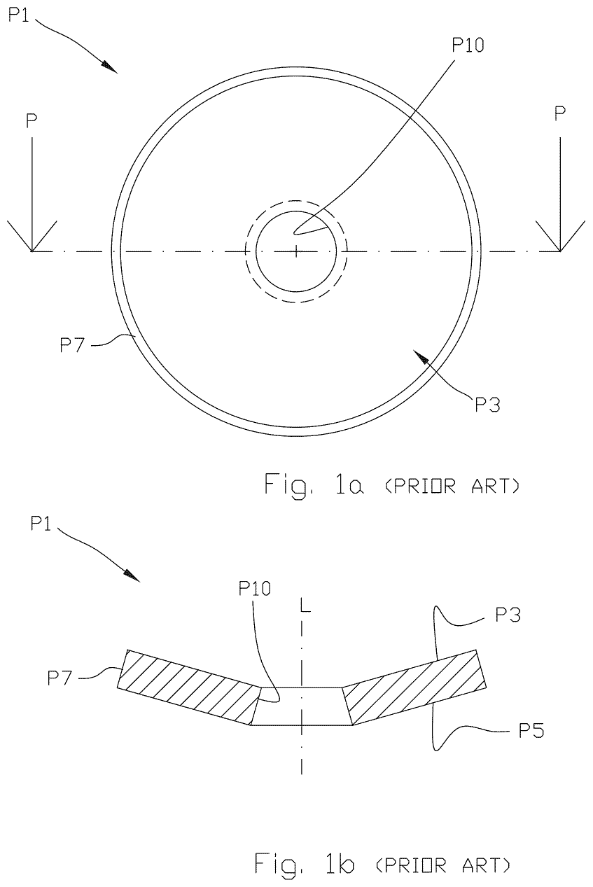

FIGS. 1a and 1b show an example of a prior art conical disc P1 or washer configured for being used in a stack of discs in a Belleville spring (not shown). The disc P1 comprises a first face P3 and a second face P5 opposite the first face P3, a central bore P10 extending through the disc P1, and a perimeter face P7. The first face P3 and the second face P5 extend rectilinearly between the bore P10 and the perimeter face P7. In a position of use in a pair of discs P1 wherein the first faces P3 face each other, a contact area between two first faces P3 facing against each other will, independently of a load compressing the discs P1, be at outer perimeter portions of the first faces P3.

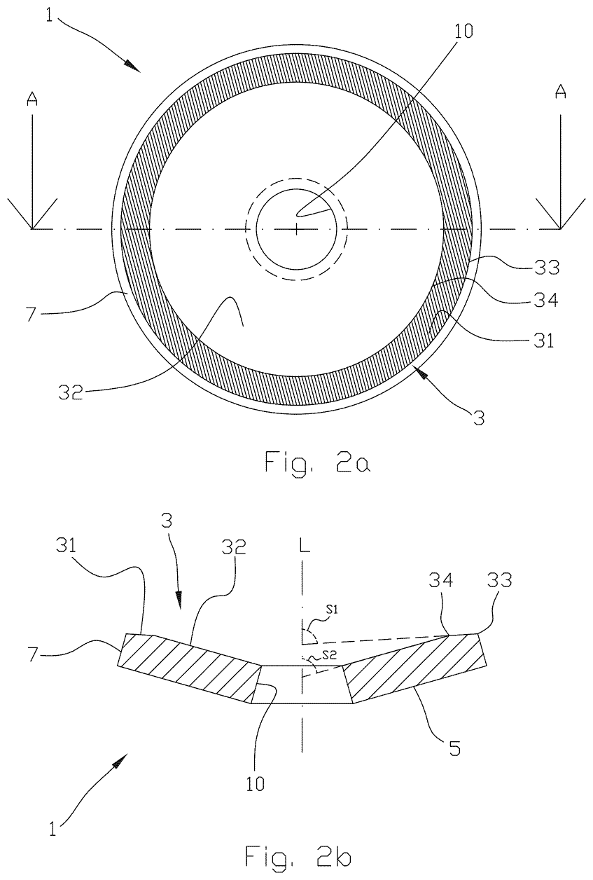

Turning now to embodiments of the invention shown in FIGS. 2a-7b, showing embodiments of the disc 1 according to the invention.

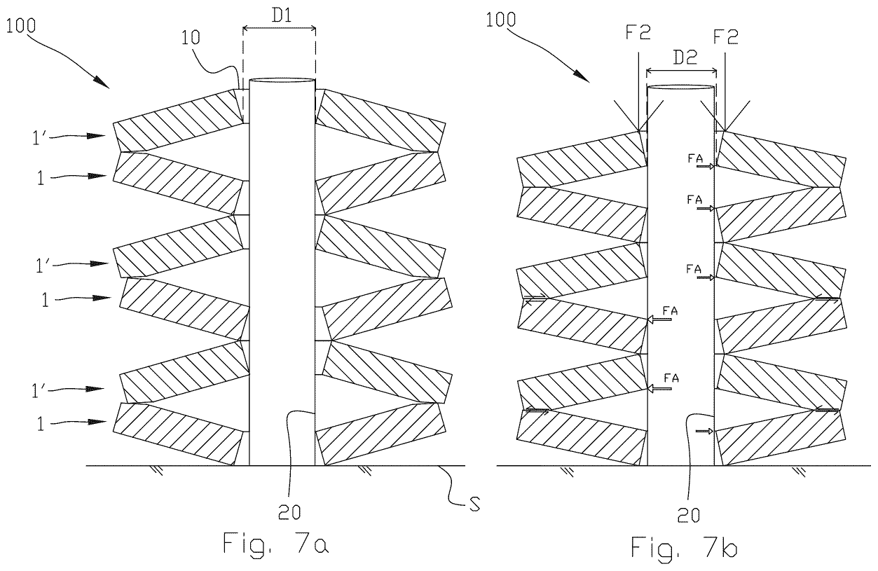

The disc 1 shown in FIGS. 2a and 2b is in an uncompressed state and comprises a first face 3 and a second face 5 opposite the first face 3. A central bore 10 extends through the disc 1. The central bore 10 is configured for receiving an aligning member 20. For example, in the embodiment shown in FIGS. 7a and 7b, the aligning member is a circular rod 20. The circular rod 20 may have a polished surface.

The first face 3 in FIGS. 2a, 2b comprises a first portion 31 extending from a perimeter face 7 of the disc 1 and a certain distance towards a central axis L above the bore 10. The first portion 31 is arranged between an edge 33 and an inner transition boundary 34 bordering a second portion 32 arranged between the first portion 31 and the central bore 10.

In FIG. 2a, the first portion 31 is, for illustrative purpose, shown hatched. In the embodiment shown, the hatched portion may illustrate a machined away portion of the first face 3. The certain distance depends on disc material and the shape of the disc 1 but may typically be in the range 30-40 % of the total distance between the perimeter of the central bore 10 and the perimeter face 7. Normally, the larger the curvature of the conical disc 1 is, the smaller the distance will be.

The first portion 31 is planar between the perimeter face 7 and the second portion 32, i.e., between the edge 33 and the inner transition boundary 34, so that the first portion 31 forms a flat surface that is planar within machining tolerances between the perimeter face 7 and the second portion 32.

As best seen in FIG. 2b, the first portion 31 is slanting from the edge 33 towards the central axis L so that the first portion 31 is arranged at first angle S1 with respect to the central axis L being less than 90° when the disc is uncompressed, i.e. unloaded.

In the embodiment shown in FIG. 2b, the second portion 32 is planar and is slanting towards the central axis L of the bore 10 so that the second portion 32 is arranged at a second angle S2 with respect to the central axis L being less than 90°. However, the first portion 31 and the second portion 32 are non-parallel and, with respect to the central axis L shown in FIG. 2b, the first angle S1 is larger than the second angle S2, i.e., with respect to the central axis L shown, a pitch or angle of gradient of the second face 32 is larger than a pitch or angle of gradient of the first face 31.

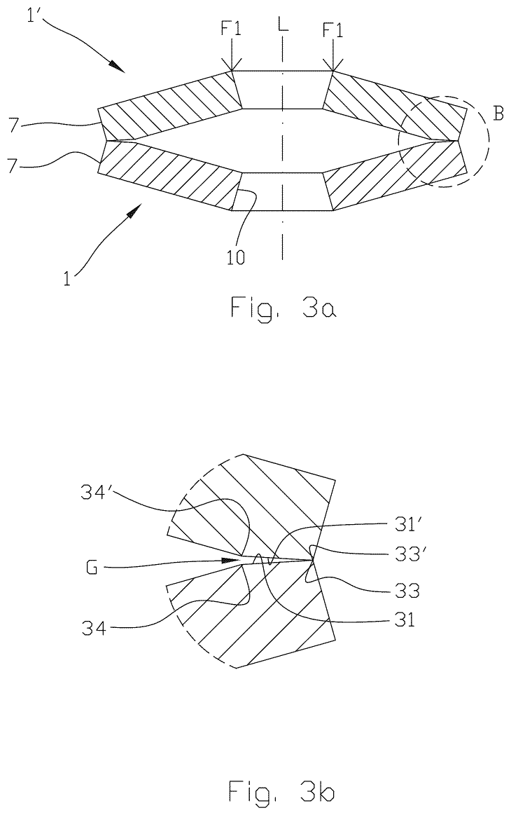

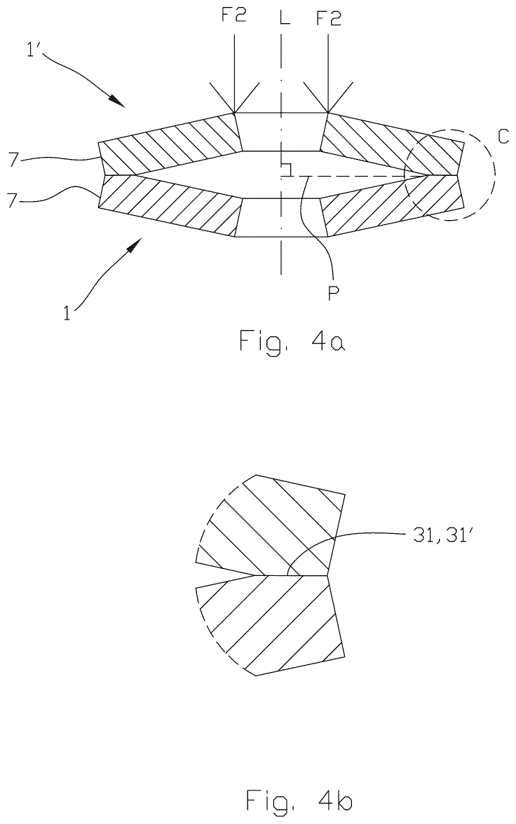

In a position of use of the disc 1 in a disc spring 100 (for example, as shown in FIGS. 7a and 7b), two discs 1,1′ are arranged as a pair of discs 1, 1′ wherein a portion of the first faces 3 abut against each other as shown in FIGS. 3a-5b . At a certain compression of such a pair of discs 1, 1′, the first portions 31, 31′ will become parallel and provide a considerably increased surface area for transferring a compression load from one disc 1 to another disc 1′ in a pair of discs 1, 1′. At a moment during compression (or unloading of a compressed pair of discs) when the first portions 31, 31′ are in parallel, the first angle S1 will be perpendicular to the central axis L of the bores 10 of the pair of discs 31, 31′, as indicated by dotted line P in FIG. 4a. With reference to FIGS. 3a to 5b, this important feature of the invention will now be discussed in detail.

FIGS. 3a and 3b illustrate a pair of discs 1, 1′ that is subject to no or only a minor external compression force illustrated by small arrows F1. In this situation, a contact between the discs 1, 1′ is at an outer, perimeter part or edge 33, 33′ of the first portions 31, 31′ that borders the perimeter face 7 of each disc 1, 1′, as best seen in FIG. 3b. The abutting planar first portions 31, 31′ provides a gap G or wedge-shaped opening facing the central axis L of the bores 10 of the pair of discs 1, 1′. Thus, the discs 1, 1′ are in contact at the edge 33, 33′ of the discs 1, 1′ only, while there is a distance between inner transition boundary 34, 34′ of the first portions 31, 31′ of the discs 1, 1′. Thus, the angle S1 shown in FIG. 2b is less than 90° with respect to the central axis L above the bore 10.

FIG. 4a illustrates the pair of discs 1, 1′ in FIG. 3a, when subject to a considerable compressive force illustrated by arrows F2, wherein the compressive force F2 exceeds the compressive force F1 illustrated in FIG. 3a. As best seen in FIG. 4b, the planar first portions 31, 31′ are parallel, meaning that the load (compressive force F2) towards the upper disc 1′ is transferred to the lower disc 1 via all of the planar first portions 31, 31′, i.e. the hatched area illustrated in FIG. 2a.

As illustrated in FIG. 4a, the planar first portions 31, 31′ are arranged perpendicular to the central axis L of the bores 10, as indicated by the dashed line P, i.e., the first angle S1 is at 90° with respect to the central axis L of the bore 10.

Depending on the configuration of the discs 1, 1′, the considerable load may for example be more than 30% of a design load. In a prototype of a disc spring assembly comprising discs 1, 1′ according to the invention, the disc spring arrived at the situation shown in FIGS. 4a and 4b when a compressive force F2 was about to reach 30 of a design load of the disc spring. A design load of a disc spring is the design load of the individual discs forming the dis spring.

A design load may typically be 75-80% of fully compressed discs. A fully compressed disc is flat in the meaning that the second portion 32 is substantially perpendicular to the longitudinal axis of the bore 10.

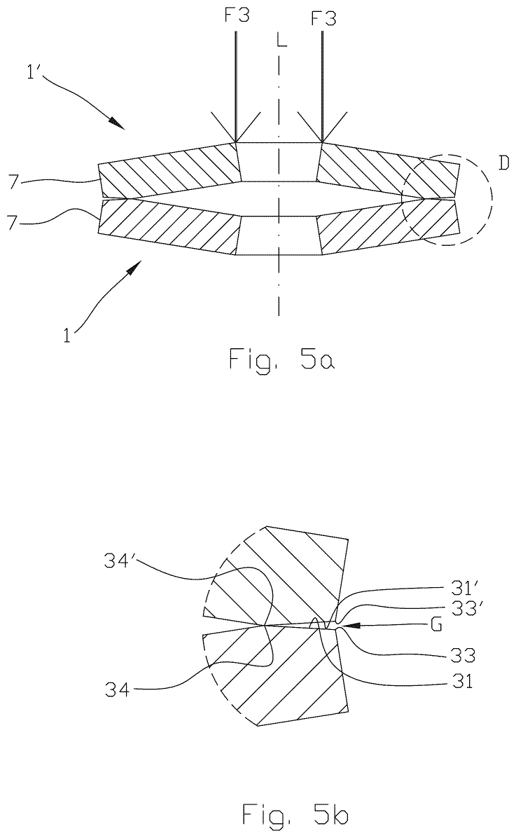

FIGS. 5a and 5b illustrate the pair of discs 1, 1′ in FIG. 4a and FIG. 4b when being subject to further increased compressive force F3 exceeding the compressive force F2 illustrated in FIG. 4a. The compressive force F3 in FIGS. 5a and 5b is at least 30% of the design load.

The contact between the discs 1, 1′ is at the inner transition boundary 34, 34′ of the first portions 31, 31′ that borders the second part 32, 32′ of each disc 1, 1′, as best seen in FIG. 5 b. The abutting first planar portions 31, 31′ provide a gap G or wedge-shaped opening facing away from the from the longitudinal axis L through central bore 10 of the pair of discs 1, 1′. Thus, the discs 1, 1′ are in contact at the inner transition boundary 34, 34′ only, while there is a distance between the edges 33, 33′ of the discs 1, 1′. Thus, the angle S1 that in FIG. 2b is smaller than 90°, is in FIG. 5a larger than 90° with respect to the central axis L of the bore 10.

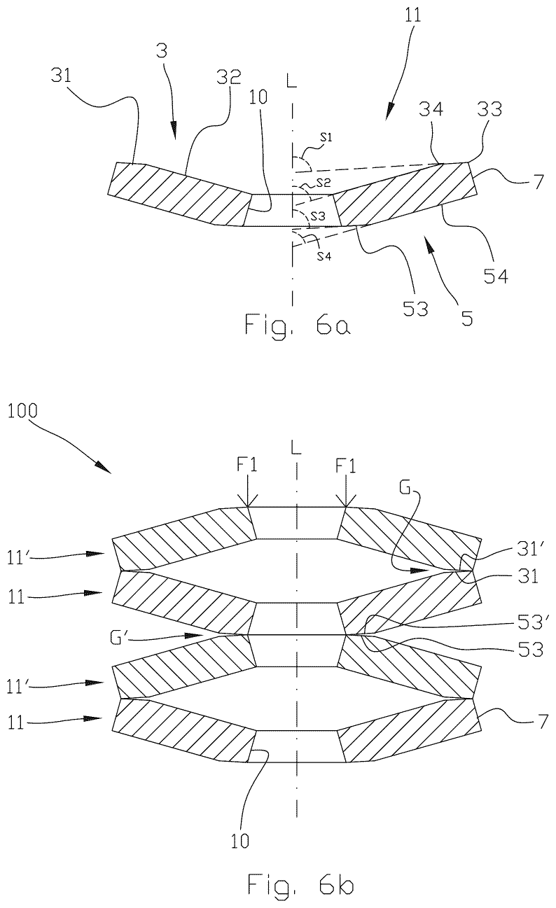

Turning now to FIG. 6a illustrating another embodiment of a disc 11 according to the invention. The disc 11 comprises the features of the first face 3 of the disc 1 shown for example in FIG. 2b. However, instead of the second face 5 of the disc 1 being rectilinear between the central bore 10 and the perimeter face 7 as illustrated in FIG. 2b, the second face 5 of the disc 11 shown in FIG. 6a comprises a planar third portion 53 slanting from the central bore 10 to a fourth portion 54. The fourth portion is arranged between the third portion 53 and the perimeter face 7 of the disc 11.

When the disc 11 is uncompressed, i.e., unloaded, the third portion 53 is arranged at an angle S3 being less than 90° with respect to the central axis L of the bore 10. Thus, when uncompressed, the third portion 53 has a first direction component being perpendicular to the longitudinal axis L of the bore 10, and a second direction component being in parallel with the longitudinal axis L of the bore 10.

The fourth portion 54 has a smooth surface that extends rectilinearly from the perimeter face 7 to the third portion 53. The fourth portion 54 is arranged at a fourth angle S4 with respect to the central axis L of the bore 10. Thus, when uncompressed, the fourth portion 54 has a direction component being perpendicular to the longitudinal axis L of the bore 10, and a direction component being in parallel with the longitudinal axis L of the bore 10. With respect to the longitudinal axis L of the bore 10, the fourth angle S4 is smaller than the third angle S3. By smaller is meant that the fourth portion 54 direction component being in parallel with the longitudinal axis L is larger than the third portion 53 direction component being in parallel with the longitudinal axis L.

FIG. 6b shows a stack 100 of two pairs of discs 11, 11′. The discs are of the type shown in FIG. 6a, wherein the discs 11′ are identical to the discs 11 but inverted. The stack 100 is subject to a compressive force F1 similar to the force illustrated in FIG. 3a. In this situation, the contact between the discs 11, 11′ is at the outer, perimeter part or edge 33 of the first portions 31, 31′ that borders the perimeter face 7 of each disc 11, 11′. The abutting planar first portions 31, 31′ provides a gap G or wedge-shaped opening (as shown in FIG. 3a) facing the central bore 10 of the stack 100 of discs 11, 11′. Similarly, the abutting planar third portions 53, 53′ provides a gap G′ or wedge-shaped opening facing away from the central bore 10 of the stack 100 of discs 11, 11′.

When a compressive force is applied to the stack 100 so that the abutting planar first portions 31, 31′ are parallel (as shown in FIG. 4a), the discs 11, 11′ may be configured so that also the planar third portions 53, 53′ are parallel. Thus, in such a configuration, the planar first portions 31, 31′ and the planar third portions 53, 53′ of each pair of discs 11, 11′ are arranged perpendicular to the central axis L of the bores 10.

When the compressive force is so that the abutting planar first portions 31, 31′ provides a gap G facing away from the central bore 10 of the stack 100 of discs 11, 11′ (similar to the illustration in FIGS. 5a and 5b), the abutting planar third portions 53, 53′ provides a gap G′ facing towards the central bore 10 of the stack 100 of discs 11, 11′.

It should be understood that the lower disc 1 in FIGS. 3a, 4a, 5a, and the lower disc 11 in FIG. 6 b, rests against a support S shown in FIG. 7 a, or another pair of discs.

Turning now to FIGS. 7a and 7b, these illustrate a principle of aligning a stacked disc spring assembly 100 comprising discs 1 of the type shown in FIG. 2b, wherein a fixed end of the assembly 100 is at a bottom support S, and a moving end is at a top. In the embodiment shown, the stacked disc spring assembly 100 comprises three pairs of discs 1, 1′ and an aligning member, here in the form of a rod 20, extending through the central bore 10 of the three pairs of discs 1, 1′.

In FIG. 7a, the disc spring assembly 100 is not subject to any external load, or only a load F1 illustrated in FIG. 3a, and is therefore in its extended, unloaded or substantially unloaded position. Each pair of discs 1, 1′ is in a state as illustrated in FIGS. 3a and 3b, i.e., a gap G between the planar first portions 31, 31′ of each pair of discs 1,1′ is towards the rod 20 in the central bore 10.

In FIG. 7b, a compressive force F2 compresses the three pairs of discs 1, 1′ so that each pair of discs 1, 1′ is in a state as illustrated in FIGS. 4a and 4b, i.e., the planar first portions 31, 31′ are parallel and fully abut against each other.

Due to the conical shape of each disc 1, 1′, A clearance between the central bore 10 of the discs 1, 1′ and the rod 20changes as the discs 1, 1′ are compressed. In the embodiment shown in FIGS. 7a and 7b, an effective diameter D1 or light opening of the central bore 10 shown in FIG. 7a is larger than the effective diameter D2 of the central bore 10 of the compressed discs 1, 1′ shown in FIG. 7b. However, whether the effective diameter of the central bore increases or reduces during a compression of the spring depends i.a. on the thickness, diameter, and the curvature of each disc. Due to this varying effective diameter of the central bore 10, a play between the central bore 10 of the discs 1, 1′ and the rod 20 is required to allow radial compression and subsequent extension of the disc spring assembly 100. In a prototype of a stacked disc spring wherein each pair of discs 1, 1′ is arranged uncompressed, a total play between the rod 20 and the central bore 10 is typically up to 1,0 mm for a disc 1 having a diameter of about 100 mm and a bore 10 of about 50 mm. When fully compressed, the play may typically be up to 1,4 mm. However, depending on the configuration of the discs 1, 1′, the play may reduce from an unloaded disc spring to a compressed disc spring, as shown in FIGS. 7a and 7b.

In the example shown in FIG. 7a, discs number two and three from the fixed, lower end of the assembly 100 are the most misaligned discs within the assembly 100. When being compressed, the gap between the planar first portions 31, 31′ of each pair of discs 1, 1′ will reduce until the planar first portions 31, 31′ are parallel for a moment, as shown in FIG. 7b, and thereafter the planar first portions 31, 31′ provide a gap towards the perimeter faces 7 of the discs 1, 1′, as shown in FIGS. 5a and 5b. Thus, during compression, an abrupt shift occurs in the contact area, which transitions from being at a portion of an outer part of the planar first portions 31, 31′, via “zero gap”, to a portion of an inner part of the planar first portions 31, 31′ abutting against each other. The abrupt shift may be referred to as a “rocking” effect. In its return cycle, this rocking effect may be repeated if any misalignment has occurred, but in the opposite order.

With respect to the self-aligning properties of a disc spring comprising discs 1, 1′ according to the invention, comprehensive tests and computer simulations have shown that the rocking effect or shifting from the initially very limited contact area at the edges 33, 33′ of the first portions 31, 31′, to the very limited contact area at the inner transition boundaries 34, 34′, as best seen in FIGS. 3b and 5b, respectively, is optimal when each disc 1, 1′ is configured so that the shifting takes place when the disc spring assembly is subject to a load being at least 30% of the design load of the disc spring assembly 100. If a shifting taking place earlier, for example at a force being 20% of the design load, makes it more likely that the shifting takes place outside of a practical working range of the disc spring. That mean the “self-alignment” process is none-existent or slow. Similarly, if the shifting takes place high up in load, when the disc spring assembly is subject to a load being greater than for example 55-60% of the design load of the disc spring assembly, a major portion of the deflection of the disc spring assembly can take place without reaching loads where “self-alignment” is achieved.

The above is also relevant for the embodiment of the invention wherein the second face 5 is provided with the first third portion 53 and the fourth portion 54.

In an operating position wherein the disc spring assembly 100 is subject to multiple cycles by a predetermined compressive force that provides the abrupt shift or rocking effect discussed above, comprehensive tests have shown that the alignment of the discs 1, 1′ takes place mostly during the moment wherein the planar first portions 31, 31′ are parallel, i.e. during the “zero-gap” moment. The alignments are caused by lateral forces FA as indicated in FIG. 7b. Due to the abrupt shift, any lateral force FA represents a “knocking” contact between the discs 1, 1′ and the rod 20. Thus, such lateral “knocking” forces FA do not present any noticeable frictional forces restricting movement of the discs 1, 1′ along the surface of the rod 20. Since the alignments of the discs 1, 1′ takes place substantially when the planar first portions 31, 31′ are parallel, i.e. during the “zero-gap” moments, the planar first portions may also be denoted as alignment planes 31, 31′. The sliding effect of the alignment planes 31, 31′ is indicated by arrows along the planes 31, 31′ of the four discs 1, 1′ being closest to the fixed end of the disc spring assembly 100 shown in FIG. 7b.

Thus, any misalignment between the discs of the disc spring assembly 100 will be gradually reduced by the lateral forces FA during multiple cycles of the assembly 100. Thereby, the disc spring assembly 100 will be subject to friction losses that are considerably lower than what is achievable by a disc spring assembly comprising prior art discs P1 as shown in FIGS. 1a and 1b.

The self-aligning effect discussed above will be achieved independently of the aligning member being in the form of a rod 20 as shown, or in the form of an external aligning member, such as for example a sleeve or other alignment means configured to enclose at least portions of the perimeter face 7 of the discs 1, 1′.

By means of a lubrication agent applied to the alignment planes 31, 31′, for example during the assembling process of the disc spring assembly 100, the alignment of the discs 1, 1′ with respect to the rod 20, will be further enhanced. This is probably due to a “floating” effect that will now be explained with reference to FIGS. 3a-5b.

When a pair of discs 1, 1′ is subject to a compression force wherein the planar first portions are initially in contact via a very limited area at the edge 33, and thereafter in contact via a very limited area at the inner transition boundary 34, as best seen in FIGS. 3b and 5b, respectively, a local stress at the contact area is high. The local stress is particularly high when the pair of discs is fully compressed as shown in FIGS. 5a and 5b. The applied force F3 is at maximum, while the contact area is less than that shown in FIGS. 3a and 3b. Due to the high stresses between the contact area of the discs 1, 1′, any lubrication may have no or only a limited effect, particularly in the compressed state as shown in FIG. 5b, since a lubricant may be displace or “swabbed” away from the contact area. However, when a pair of discs 1, 1′ in a disc spring assembly 100, rocks via the position wherein the planar first portions 31, 31′ are parallel, i.e. during the “zero-gap” moment discussed above and shown in FIGS. 4a and 4b, a local stress from the load F2 will be considerably reduced due to the relatively large area of the planar first portions 31, 31′. The reduced local stress, together with the short contact period, is a conceivable reason for the floating effect and thereby the enhanced alignment achieved by a lubrication.

Although a lubricant will further enhance a self-aligning effect of disc spring assembly 100, the main effect is still achieved by means of the individual discs 1, 1′ as disclosed herein.

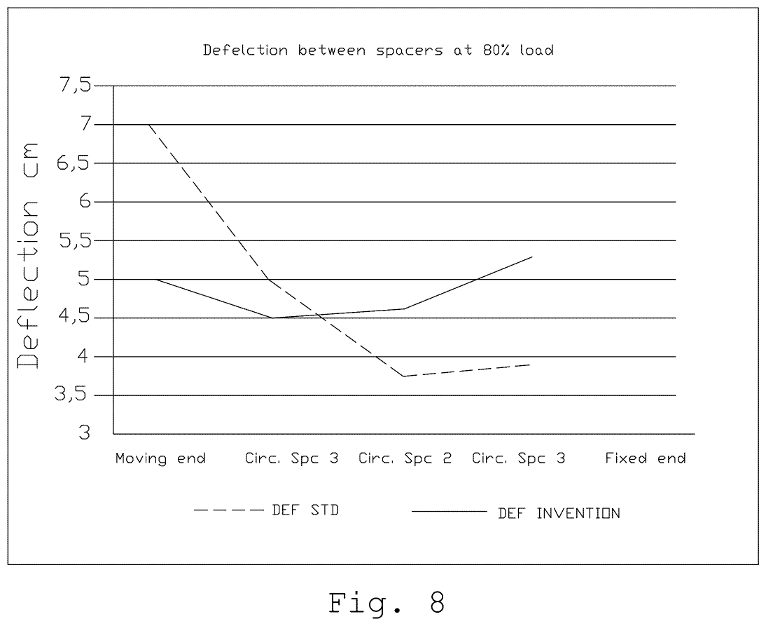

FIG. 8 shows results from tests of a disc spring made from prior art discs P1 shown in FIGS. 1a and 1b, and a disc spring made from discs 1 according to the invention. Each disc spring was assembled from four sections of discs wherein the sections were separated by three circular spacers equidistantly arranged between the fixed end and the moving end of the disc spring. Each section comprised 18 pairs of discs and had an uncompressed length of about 35 cm. Thus, a total length of the disc spring was about 1,6 m. A cyclic load of 80% of the design strength or stroke was applied to the moving end of the disc springs. The results of the tests are shown as dashed line “DEF STD” for the disc spring made from prior art discs, while the continuous line “DEF INVENTION” for the disc spring made from discs according to the invention.

A deflection of 7 cm was measured at the moving end of the prior art disc spring, and a deflection of about 3,9cm was measured at the spacer being closest to the fixed end of the spring. For the type of prior art discs used in the test, a deflection of 7 cm compression in a section means about 100% compression. A disc may only be 100% compressed a few times until fatigue. The extreme difference in deflection between moving end and the fixed end means that a substantial portion of the applied load is unevenly distributed along the stack of disc springs due to internal friction of the disc spring.

As shown in FIG. 8, the results DEF INVENTION from the disc spring made from discs according to the invention resulted in a deflection of only 5 cm at the moving end of the disc spring. The deflection was relatively evenly distributed along all four sections, with a maximum difference between the sections being less than 0,8 cm. Thus, a disc spring made from discs according to the invention mitigates the problems of prior art. Comprehensive tests show that a fatigue life of the discs is considerably increased.

From the disclosure herein, it should be clear that the self-alignment of the disc spring assembly 100 is provided by small corrections taking place every time the stack of disc springs is compressed or relieved past the force that brings the planar first portions 31, 31′ or alignment planes into parallel alignment, i.e., provided the rocking effect between the discs 1, 1′. The rocking effect is a way of describing an abrupt shift in the forcefield when the point of attack for the spring compression shifts from one diameter to another. Given the presence of a side-forces FA between the discs 1, 1′ caused by interference from the guiding device, such as the alignment member 20, the discs 1, 1′ can quite easily be shifted or knocked sideways and free from interference during this period. The “rocking” or fast shift in forcefield provides a relief of friction between the perimeter of the internal bore 10 and the aligning member 20. Thus, when subject to a cycling force above a certain magnitude, any side-force acting on individual discs 1, 1′ of the disc spring 100 comprising discs 1 according to first aspect of the invention will gradually align and free up the spring with reference to the guiding devices radially until the stack of disc springs is aligned and cycles at the lowest possible friction.

Thus, as discussed above, friction is the main barrier for having long-stroke disc springs. The self-aligning effect of the disc spring assembly according to the invention makes it possible to achieve longer, or larger, stacks of discs with an acceptable hysteresis, which opens for more and better solutions in mechanical systems needed in the industry. Also, a need for friction reducing measures is reduced. Friction reducing measures may comprise lubrication of the disc spring and, for example, a very expensive chromium plating of an aligning member.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A disc for a disc spring, the disc comprising:
a first face forming a surface of a concave face of the disc;
a second face opposite the first face;
a central bore extending through the disc; and
a perimeter face
the first face comprising:
a first portion having a direction component extending radially from the perimeter face towards a central axis of the bore; and
a second portion between the first portion and the central bore wherein the first portion is planar and arranged at a first angle with respect to the central axis of the bore, and the second portion comprises at least a part arranged at a second angle with respect to the central axis of the bore wherein the second angle is smaller than the first angle;
wherein the disc is configured so that the first angle is smaller than 90° with respect to a central axis of the bore when the disc is unloaded, and the first angle is larger than 90° with respect to the central axis of the bore when the disc is subject to a load being at least 30% of a design load of the disc
wherein the second face comprises:
a third portion extending from the bore and towards the perimeter face and having a direction component extending radially from the central axis through the bore; and
a fourth portion between the third portion and the perimeter face,
wherein the third portion is planar and arranged at a third angle with respect to the central axis of the bore, and the fourth portion comprises at least a part arranged at an acute fourth angle with respect to the central axis of the bore, and
wherein the fourth angle is smaller than the third angle.

2. The disc according to claim 1, wherein the disc is configured so that first angle changes from an acute angle to an obtuse angle when the disc is subject to a load being in the range of 30-50% of the design load of the disc.

3. The disc according to claim 1, wherein the fourth portion (of the second face extends rectilinearly from the central axis of the bore to the third portion.

4. (canceled)

5. The disc according to claim 1, wherein the disc is configured so that the third angle is smaller than 90° with respect to a central axis of the bore when the disc is unloaded, and the third angle is larger than 90° with respect to the central axis of the bore when the disc is subject to a load being at least 30% of a design load of the disc.

6. The disc according to claim 56, wherein the disc is configured so that third angle changes from an acute angle to an obtuse angle when the disc is subject to a load being in the range of 30-50% of the design load of the disc.

7. The disc according to claim 5, wherein the angle of the third portion is similar to the angle of the first portion.

8. A disc spring assembly comprising:
pairs of discs , wherein each disc in the pairs of discs includes a disc according to claim 1; and
an aligning member for radially aligning the pairs of discs wherein, in each pair of discs, a portion of the first face of one disc abuts against a portion of the first face of another disc,
wherein the first portions in a pair of discs form a gap facing a central axis of the bores of the discs when the assembly is uncompressed, and a gap facing the perimeter face when the disc spring assembly is subject to a compressive force being at least 30% of the design load of the disc spring assembly.

9. The disc spring assembly according to claim 8, wherein the aligning member is a mandrel arranged through the central bore of each pair of discs.

10. The disc spring assembly according to claim 8, wherein the aligning member is a guide encompassing at least portions of the perimeter faces of the discs.

11. A method for aligning a disc spring assembly according to claim 8, wherein the method comprises the step of providing an axial load on a moving end of the disc spring assembly so that the disc spring is compressed to at least allow the first portions of the first faces in a pair of discs to be parallel.

12. The method according to claim 11, comprising applying compressive force sufficient to provide an abrupt shift so that a contact area between the discs is shifted from the edges at the perimeter of the discs to the transition boundaries when the disc spring assembly subject to a load being in the range of 30-50% of the design load of the disc.

13. The disc according to claim 2, wherein the fourth portion of the second face extends rectilinearly from the central axis of the bore to the third portion.

14. The disc spring assembly according to claim 9, wherein the aligning member is a guide encompassing at least portions of the perimeter faces of the discs.

15. A method for aligning a disc spring assembly according to claim 9, wherein the method comprises the step of providing an axial load on a moving end of the disc spring assembly so that the disc spring is compressed to at least allow the first portions of the first faces in a pair of discs to be parallel.

16. A method for aligning a disc spring assembly according to claim 10, wherein the method comprises the step of providing an axial load on a moving end of the disc spring assembly so that the disc spring is compressed to at least allow the first portions of the first faces in a pair of discs to be parallel.
